(19) United States
(12) Patent Application Publication
(10) Pub. No.: US 2004/0103789 A1
(43) Pub. Date: Jun. 3, 2004

(54) Fume-treating device and fume ducting system for cooker hoods

(76) Inventors: Chin I. Lan, Tao Yuan City (TW); Tien Hua Hsu, Ta Yuan Hsiang (TW)

Correspondence Address: Chin-I Lan, PO Box 82-144, Taipei, TW

(21) Appl. No.: 10/716,593

(22) Filed: Nov. 20, 2003

(30) Foreign Application Priority Data
Nov. 29, 2002 (CN) 02286483.0
Nov. 29, 2002 (CN) 02 2 86482.2

(51) Int. Cl. B01D 53/02; B01D 46/00

(52) U.S. Cl. 96/146; 96/134; 55/490.1; 55/385.1

(57) ABSTRACT

A fume-treating device and fume ducting system for cooker hoods is disclosed. The top section of the bottom fume passage is mounted with a top fume passage and the side of the bottom fume passage is at least a bottom fume-suction inlet, which is a detachable structure. The top section of the top fume passage corresponding to the top section of a stove is provided with a top fume suction inlet. The apparatus is suitable for use in a site where large amount of fume is discharged. The bottom fume outlet corresponding to the inner side of the fume passage is provided with a fume filter. The rising fume passes through an active carbon filter before it is discharged to the environment.

### BACKGROUND OF THE INVENTION

(a) Technical Field of the Invention

The present invention relates to a fume-treating device and fume ducting system for cooker hoods, and in particular, to a device which treats fume that pollutes the environment. The improved structure of the fume passage of the device is adapted for treatment of large volume of fume.

(b) Description of The Prior Art

A cooker hood with ducting system is used to reduce fume and to clean air around the kitchen. As shown in FIG. 1, a conventional cooker hood has an inlet for fume at the rear top section of the device and a passage at the bottom section of the inlet. The wall of the passage has an outlet, which is in communication with the ventilation fan of the cooker hood, and the passage, the tube of the cooker hood and the ventilation fan are provided in a kitchen cupboard. The cooker hood seems to be very neat and clean. However, the conventional cooker hood has the following drawbacks:

(1) Large amount of untreated fume discharged to the environment will pollute the environment.

(2) If the cooker hood has not been used for a long time, the untreated fume will contaminate the blades of the cooker hood and thus the cooker hood may not be operable.

(3) If one of the units in a building has not treated the fume, the entire building will be contaminated due to the communication of the fume passage.

In view of the above, it is an object to provide a fume-treating device and fume ducting system for cooker hoods to mitigate the above drawbacks.

### SUMMARY OF THE INVENTION

Accordingly, it is an object of the present invention to provide a fume treating device and fume passage of a cooker hood having a bottom fume passage and a top fume passage, characterized in that the top portion of the bottom fume passage is provided with the top fume passage and the side of the bottom fume passage is a bottom fume-suction inlet in communication with the top fume passage, a protruded platform of the bottom section of the bottom fume-suction inlet is mounted at the bottom fume passage inlet, and the fume-suction inlet is detachable which is an oil-suction framework having a pivot rod for the inclined board of the bottom fume passage, and an oil suction material is provided at the oil suction framework, the top end of the top fume passage corresponding to the top portion of a stove is mounted with a top fume-suction inlet, and two protrusions are provided to the top of the inclined board of the bottom fume passage, the protrusions and the side wall of an outlet form into an engaging slot for mounting a filter thereon, and the outlet of the bottom fume passage corresponding to the inner side of the fume passage is provided with a fume filter, and a securing frame is used to secure a ventilation fan connected to one end of a tube.

Yet another object of the present invention is to provide a fume-treating device and fume ducting system for cooker hoods, wherein the fume filter is a dual layered active carbon filter.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a conventional cooker hood.

FIG. 2 is a perspective view of a cooker hood in accordance with the present invention.

FIG. 3 is a schematic view showing the bottom fume passage in accordance with the present invention.

FIG. 4 is a schematic view showing the inlet of the bottom fume passage of the present invention.

FIG. 5 is a schematic view of the top fume passage of the present invention.

FIG. 6A is a schematic view of a filtering structure of the present invention.

FIG. 6B is a schematic view of another filtering structure of the present invention.

FIG. 7 is a schematic view of an air-sucking framework of the present invention.

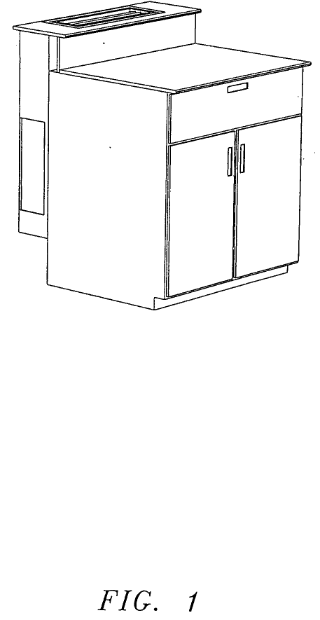

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

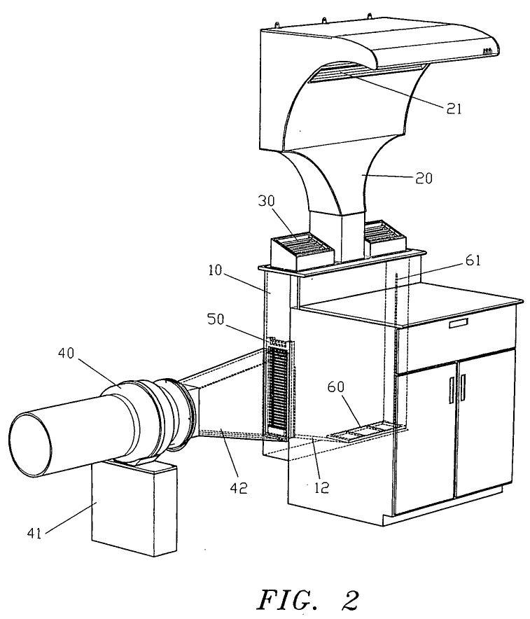

Referring to FIG. 2, there is shown a fume-treating device and fume ducting system for cooker hoods comprising a bottom fume passage 10 and a top fume passage 20, and a ventilator 40. The cooker hood in accordance with the present invention is mounted at the rear side of the kitchen cupboard.

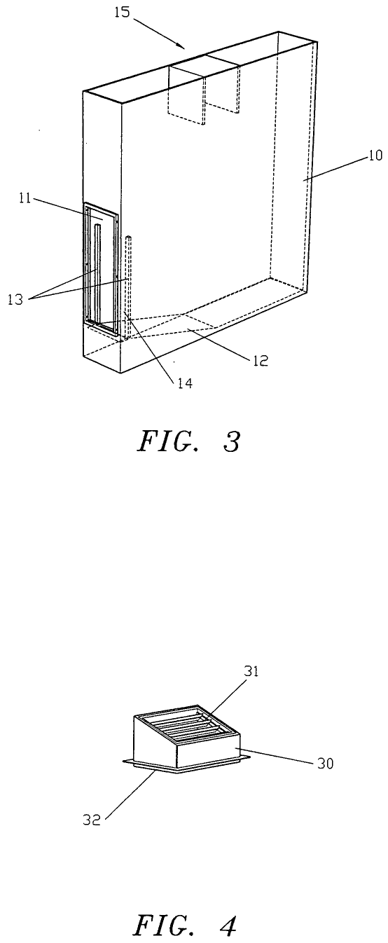

The two sides at the top section of the bottom fume passage 10 (as shown in FIG. 3) are provided with two bottom fume-suction inlets 30, and the top end face of the bottom fume-suction inlets 30 is a sloping face, and the opening of the inlets 30 is provided with rotatable blades 31 and the two bottom fume-suction inlets 30 are detachable, which can be unloaded from the cooker hood. The fume-suction inlets 30 are positioned at the air-inlet 15 at the two sides of the fume passage. The bottom section of the inlets 30 is a protruded platform 32, facilitating mounting onto the air-inlet, as shown in FIG. 4.

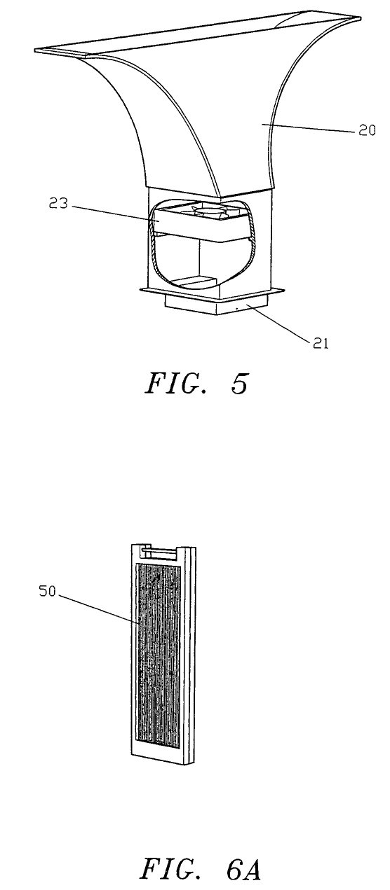

The top fume-passage 20 is positioned at the middle air-inlet 15 of the bottom fume passage 10 which can be manufactured with the bottom fume passage 10 as one unit, or a protruded platform 22, (as shown in FIG. 5) is positioned at the bottom section of the top fume passage 20. The protruded platform is engaged at the middle air inlet of the bottom fume passage. At the top portion of the top fume passage, corresponding to the head portion of the stove, a top fume-suction inlet 21 is provided. Due to the fact that the ventilator 40 is far away from the top fume suction inlet, the interior of the top fume passage is provided with another ventilator 23. This ventilator 23 will greatly increase the suction at the fume inlet. If the volume of the fume is low, the additional ventilator 23 can be switched off.

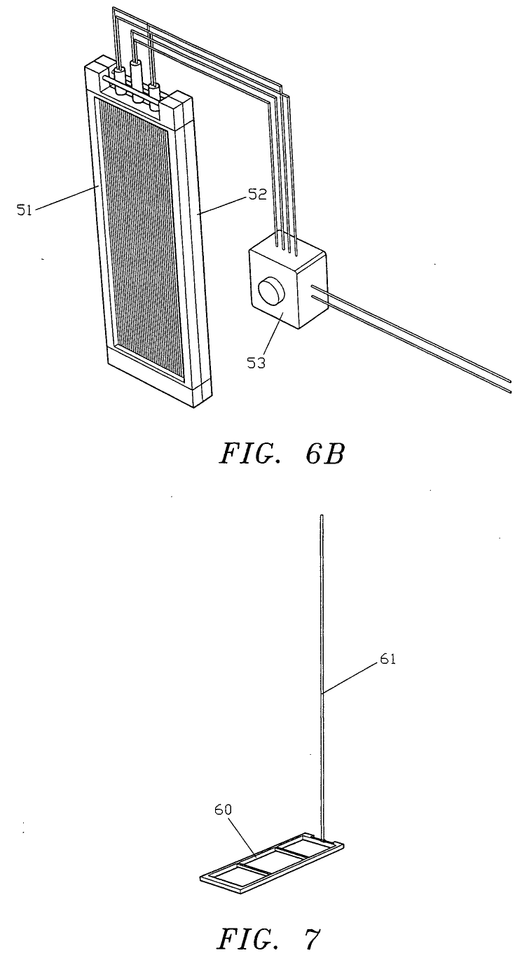

At least one of the bottom fume suction inlets 30 is detachable and the rest of the inlets 30 can be made as one unit with the bottom fume passage 10. The side wall of the bottom fume passage has an air outlet 11, and the inner side of the bottom section of the air outlet is provided with inclined sloping plates 12, and the top section of the plate is provided with the two protrusions 13. The two protrusions and the sidewall of the air outlet form into an engaging slot 14. The interior of the engaging slot is provided with a fume filter 50, as shown in FIG. 6A, which is used for filtering of fume. The filter 50 is either constant temperature stainless wire filter 51 or active carbon filter 52, as shown in FIG. 6B. The bottom section of the inclined sloping plate is an oil suction framework 60, as shown in FIG. 7, which is used for placing of oil absorbing material, for instance, oil absorbing cloth, etc. One side of the oil suction framework is pivotally mounted with a pulling rod 61, which facilitates the operation of the pulling rod 61. Generally, it is position at the detachable bottom fume suction inlet and it is beneficial for changing or replacement of filter and oil absorbing cloth. In the present preferred embodiment, the inlets are detachable.

The ventilator 40 is secured onto a securing frame 41 and one end of the frame 41 passes through the tube 42 and is connected to the air outlet 11 of the bottom flume passage 10. The other end is discharged into the air. In accordance with the present invention, the ventilator is arranged in vertical, and the cooker hood has a lower noise and is not easily damaged.

As shown in FIG. 6B, when using the cooker hood, fume passes through the constant stainless wire filter 51 and the active carbon filter 52 before it is discharged into the atmosphere, and any poisonous materials in the fume are filtered. Thus, polluted air is prevented from entering into the atmosphere.

The active carbon has a strong absorbing ability and fume contaminant of the ventilator 40 is lesser and will not stop the ventilator from rotating. Besides, the filter 50 can filter the fume contained in the fume passage even the cooker hood is in operation so that fume runs into the kitchen.

The lower section of the filter 50 within the bottom fume passage 10 is provided with an inclined plate 12. Before the cooker hood is in operation, as shown in FIG. 6B, the control switch 53 of the stainless wire filter 51 is ON and the heat at the stainless wire filter will heat up the contaminant and the contaminant is melted and flows down the inclined plate. The inner wall of the top fume passage 20 is stainless steel and the contaminant will flow to the oil suction frame 60 and absorb by the oil absorbing cloth. The user needs only to open the fume inlet and lift up the pulling rod 61, then, the oil suction frame is pulled out and the oil absorbing cloth is replaced. The filter can be withdrawn by opening the bottom fume suction inlet 30 and is discharged from the air inlet 15 at the top portion of the fume passage. The filter can be washed or replaced. Thus the cooker hood is cleaned. Further, the filter 50 is not restricted to single-layered stainless filter wire 51 and a single-layered active carbon filter 52, but can also be double-layered stainless filter wire and double-layered active carbon.

When in operation of the cooker hood, if one portion of the fume has yet to completely discharge to the atmosphere but is sucked by the bottom fume air inlet 30, when the fume is excessively large and there is still a portion continuously to rise upward, the fume will be sucked by the top fume suction inlet 21. Thus, the cooker hood in accordance with the present invention overcomes the drawbacks experienced in those conventional cooker hoods.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

We claim:

1. A fume treating device and fume passage of a cooker hood having a bottom fume passage and a top fume passage, characterized in that the top portion of the bottom fume passage is provided with the top fume passage and the side of the bottom fume passage is a bottom fume-suction inlet in communication with the top fume passage, a protruded platform of the bottom section of the bottom fume-suction inlet is mounted at the bottom fume passage inlet, and the fume-suction inlet is detachable which is an oil-suction framework having a pivot rod for the inclined board of the bottom fume passage, and an oil suction material is provided at the oil suction framework, the top end of the top fume passage corresponding to the top portion of a stove is mounted with a top fume-suction inlet, and two protrusions are provided to the top of the inclined board of the bottom fume passage, the protrusions and the side wall of an outlet form into an engaging slot for mounting a filter thereon, and the outlet of the bottom fume passage corresponding to the inner side of the fume passage is provided with a fume filter, and a securing frame is used to secure a ventilation fan connected to one end of a tube.

2. The fume treating device and fume passage of a cooker hood of claim 1, wherein the fume filter is a dual layered active carbon filter.

3. The fume treating device and fume passage of a cooker hood of claim 1, wherein the fume filter has a layer being a constant temperature steel wire net and a second layer being an active carbon filtering layer.

4. The fume treating device and fume passage of a cooker hood of claim 1, wherein the fume filter is a dual layered constant temperature steel wire net.

5. The fume treating device and fume passage of a cooker hood of claim 1, wherein the fume passage of the top fume passage is mounted with a ventilation fan.
